(19) United States
(12) Patent Application Publication
(10) Pub. No.: US 2021/0245354 A1
(43) Pub. Date: Aug. 12, 2021

(54) STRUCTURE OF RATCHET WRENCH

(71) Applicant: YUN CHAN INDUSTRY CO., LTD., New Taipei City (TW)

(72) Inventor: Fu-Jui Hsiao, New Taipei City (TW)

(21) Appl. No.: 16/934,011

(22) Filed: Jul. 21, 2020

(30) Foreign Application Priority Data
Feb. 7, 2020 (TW) 109201378

(51) Int. Cl. B25G 1/04; B25B 13/46; B25B 23/00; B25G 1/08

(52) U.S. Cl. CPC B25G 1/043; B25G 1/085; B25B 23/0035; B25B 13/463

(57) ABSTRACT

A ratchet wrench includes a wrench body, a plurality of sliding sections defined on the wrench body, a main-body hollowed section formed in the wrench body, a ratchet assembly arranged at one side of the wrench body; an accommodation piece arranged on the wrench body, at least one accommodation section formed in the accommodation piece, an extension housing slidably coupled to the wrench body, and a plurality of sliding channel sections arranged in the extension housing to correspond to and connect with the sliding sections. To increase the overall length, the wrench body is slid out of the extension housing. To stow at least one tool bit, the tool bit is positioned in the accommodation section. In this way, the length of force arm is adjustable and a function of storage is provided. Further, the formation of the main-body hollowed section helps reduce weight and lower cost.

### TECHNICAL FIELD OF THE INVENTION

The present invention relates to a structure of a ratchet wrench that provides a function of storage, enables adjustment of a length of a force arm and reduction of weight, and saves cost.

### DESCRIPTION OF THE PRIOR ART

A wrench or spanner is a tool that is commonly used to rotate bolts, nuts, and other objects that are not easily rotated by bare hands. Various types of wrench are available, including open-end wrench, box-end wrench, adjustable wrench, hex key, and ratchet wrench.

The known structure of ratchet wrench suffers, during the use thereof, certain drawbacks, which may be further improved:

(1) The length of the known wrench is not adjustable, and a fixed length of force aim makes it impossible to use in different applications.

(2) Tool bits that are used with the known ratchet wrench are often small in size, making it hard for storage and easy to miss.

(3) A body of the known wrench is generally made of a solid metallic material, making it heavy in weight and requiring a high cost of fabrication.

### SUMMARY OF THE INVENTION

The primary objective of the present invention is to enable adjustability of a length of the entirety of a force arm by incorporating a structure having an extension housing, in order to be useable in various applications.

Another objective of the present invention is to enable stowage of tool bits in an accommodation piece by incorporating a structure having an accommodation section, in order to fulfill a function of storage.

To achieve the above objectives, the present invention has a main structure that comprises: a wrench body. The wrench body is formed thereon with a plurality of sliding sections. The wrench body is formed with a main-body hollowed section. The sliding sections are arranged at two sides of the main-body hollowed section. The wrench body is provided, at one side thereof, with a ratchet assembly. The wrench body is also provided with an accommodation piece. The accommodation piece is at a location corresponding to the main-body hollowed section. The accommodation piece is formed with at least an accommodation section. The wrench body is slidably arranged in an extension housing. The extension housing is provided with a plurality of sliding channel sections that are respectively engageable with and connectable with the sliding sections.

A user, intending to use the present invention to carry out tightening and requiring an extended force arm to apply an enlarged torque, may use the structural arrangement of the sliding sections being connectable, in a relatively slidable manner, with the sliding channel sections to slide the wrench body out of the extension housing to increase an overall length. Under such a condition, the user may attach a tool hit to the ratchet assembly and hold the wrench body and the extension housing to carry out twisting for tightening.

After use, to stow or store the tool bit, the tool bit can be positioned into the accommodation section of the accommodation piece, and finally, the wrench body is returned hack into the extension housing to fulfill the purpose of storage. As such, by means of the structural arrangement of the extension housing, the overall length of force arm can be increased to allow the present invention to be used in various applications. And, by means of the structural arrangement of the accommodation section, storage of a tool bit, after use, can be realized. Further, by means of the structural arrangement of the main-body hollowed section, effects of saving material and reducing weight can be achieved.

### BRIEF DESCRIPTION OF THE DRAWINGS

FIG. 1 is a perspective view showing a preferred embodiment of the present invention.

FIG. 2 is an exploded view showing the preferred embodiment of the present invention.

FIG. 3 is a perspective view showing a portion of the preferred embodiment of the present invention.

FIG. 3A is a perspective view showing a portion of the preferred embodiment of the present invention.

FIG. 3B is a cross-sectional view showing the preferred embodiment of the present invention.

FIG. 4 is a schematic view showing extending of the preferred embodiment of the present invention.

FIG. 5 is a schematic view showing stowing of the preferred embodiment of the present invention.

FIG. 6 is a perspective view, in a see-through form, showing a portion of another preferred embodiment of the present invention.

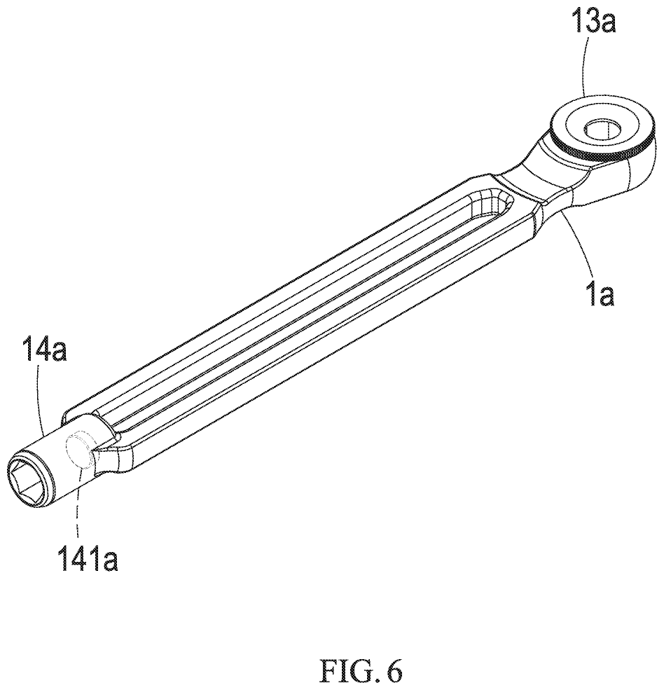

FIG. 7 is a schematic view showing twisting of said another preferred embodiment of the present invention.

FIG. 8 is an exploded view showing a further preferred embodiment the present invention.

FIG. 9 is a schematic view showing retaining engagement of said further preferred embodiment of the present invention.

FIG. 10 is another schematic view showing retaining engagement of said further preferred embodiment of the present invention.

FIG. 11 is a cross-sectional view showing said further preferred embodiment of the present invention.

### DETAILED DESCRIPTION OF THE PREFERRED EMBODIMENT

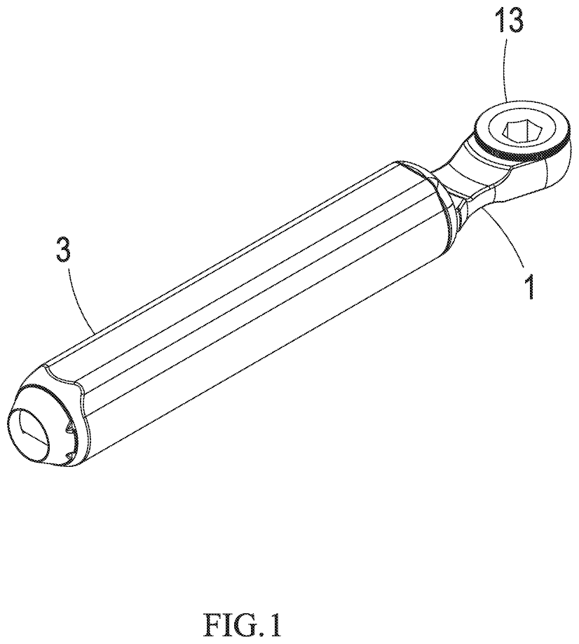

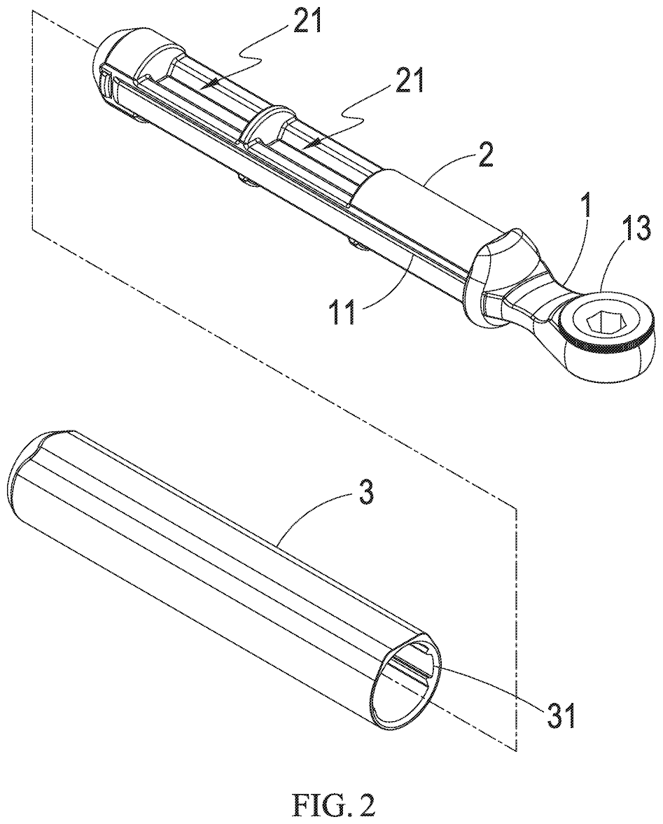

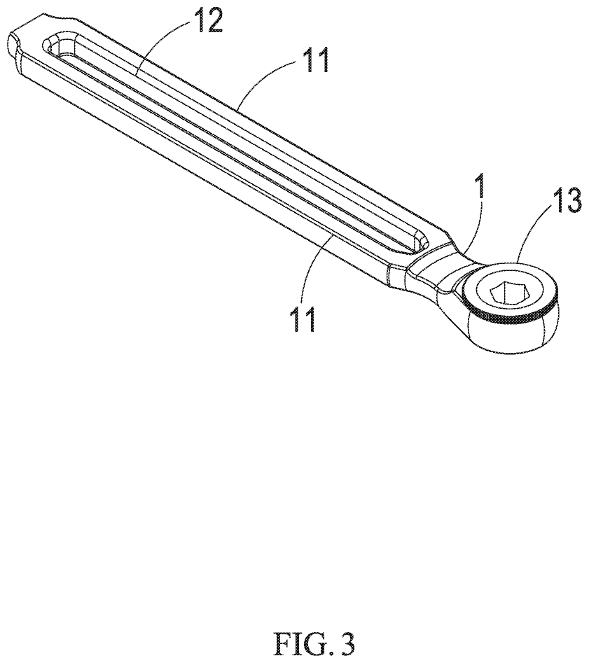

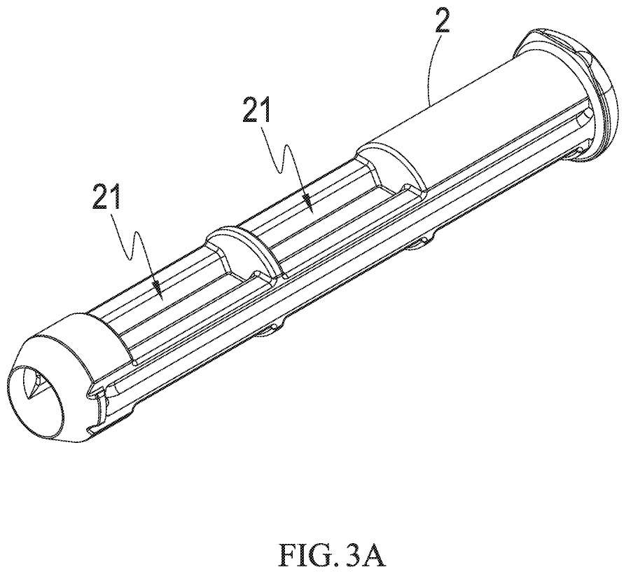

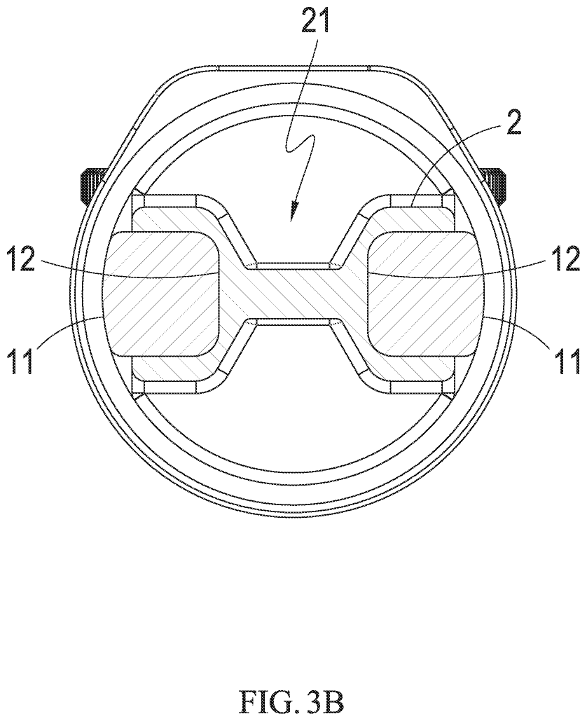

Referring to FIGS. 1-3B, the present invention comprises:

a wrench body 1, the wrench body 1 being formed thereon with a plurality of sliding sections 11;

a main-body hollowed section 12, the main-body hollowed section 12 being formed in the wrench body 1, the sliding sections 11 being arranged at two opposite sides of the main-body hollowed section 12;

a ratchet assembly 13, the ratchet assembly 13 being arranged at one side of the wrench body 1;

an accommodation piece 2, the accommodation piece 2 being arranged on the wrench body 1 at a location corresponding to the main-body hollowed section 12;

at least an accommodation section 21, the accommodation section 21 being formed in the accommodation piece 2; and

an extension housing the extension housing 3 comprising a plurality of sliding channel sections 31 respectively corresponding to and connectable with the sliding sections 11 to enable sliding of the wrench body 1 in an interior of the extension housing 3.

Preferably, the main-body hollowed section 12 is made as an elongate opening formed in a middle of the wrench body 1.

Preferably, the wrench body 1 includes a material of metal, which is provided as an example.

Preferably, the accommodation piece 2 includes a material of plastic, which is provided as an example.

Preferably, the accommodation section 21 has a quantity of five, which is provided as an example, and arranged on a top side and a bottom side of the wrench body 1.

The above description provides an explanation and understanding of the structure of the present inventive technique, and based on a combined assembly of such a structure, adjustability of a length of force arm, reduction of a weight, saving of cost, and fulfillment of a function of storage are achieved. Details will be further provided below.

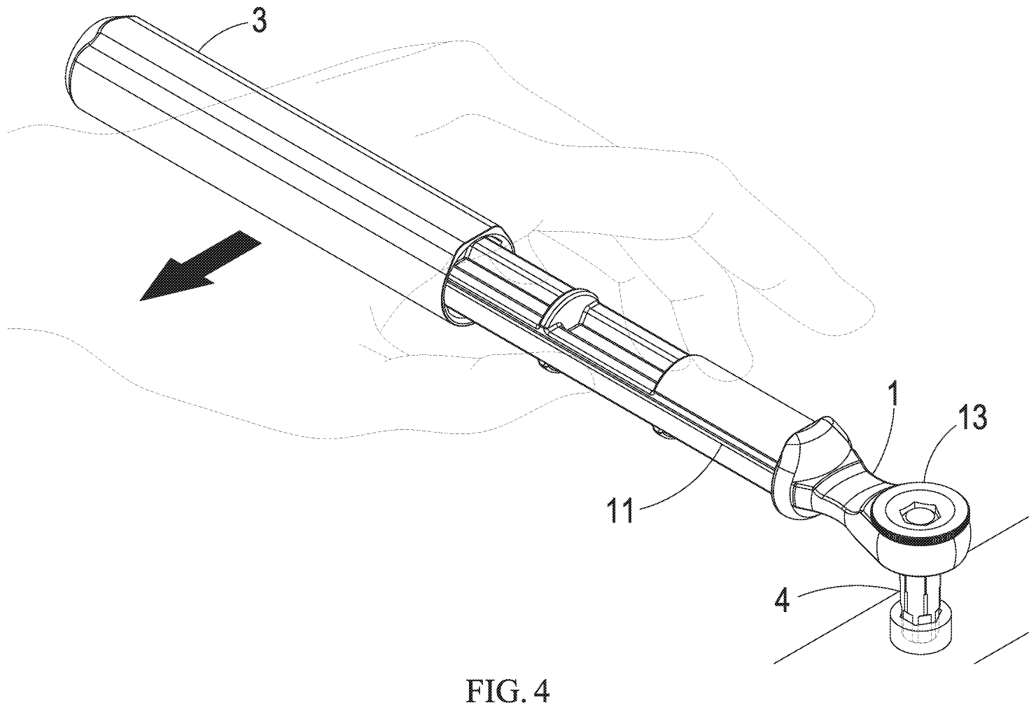

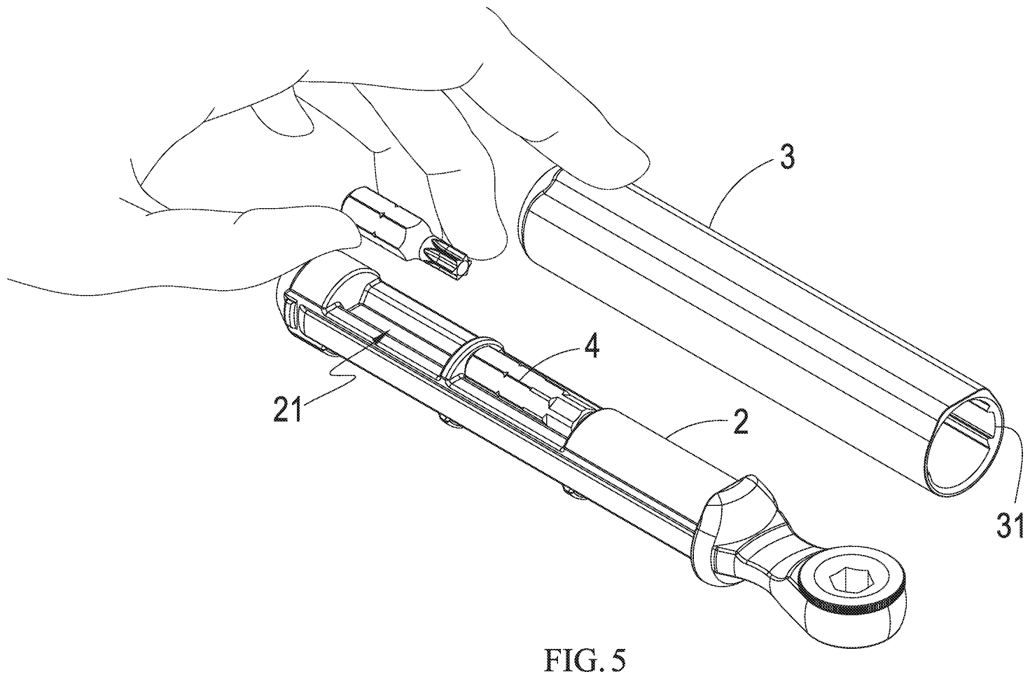

Referring to FIGS. 1-5, to carry out a tightening operation of a bolt, it is often that force application is limited due to an insufficient length of force arm, and with the structure according to the present invention, when a user attempts to use an increased length of force arm to apply an enlarged torque for the tightening operation, the structural arrangement of the sliding sections 11 being connectable, in a relatively slidable manner, with the sliding channel sections 31 allows the wrench body 1 to slide out of the extension housing 3.

Under such a condition, an overall or entire length of force arm is a length of the wrench body 1 plus a length of the extension housing 3. When the user attempts to carry out the tightening operation with the present invention, it only needs to mount a tool bit 4 to the ratchet assembly 13, align the tool bit 4 with and couple to the bolt, and hold the wrench body 1 and the extension housing 3 at the same time to carry out rotating, so that an increased length of force arm is applied to provide an enlarged torque to the bolt, making it usable in various applications.

In the present invention, the ratchet assembly 13 is operable by means of mutual engagement between a pawl and a toothed wheel that are arranged in an interior thereof to allow the ratchet assembly 13 to drive the tool bit 4 to rotate in only one specific direction, and the tool bit 4 does not rotate is rotation is made in a reverse direction. Based on such a structural arrangement, reversing is prevented and the user may quickly tighten a bolt that is set in engagement with the tool bit 4 through just repeated oscillation. Thus, there is no need to disengage the tool bit 4 from the bolt after each twist or turn and re-set a proper angle for re-engagement, and as such, the time consumed for the operation can be reduced.

After use, to stow or store the tool bit 4, the tool bit 4 is first removed from the ratchet assembly 13 and then positioned into the accommodation section 21 of the accommodation piece 2, and finally, by means of the structural arrangement of the sliding sections 11 and the sliding channel sections 31 being in relatively slidable engagement and coupling with each other, the wrench body 1 is slid back into the extension housing 3 to fulfill stowage or storage of the tool bit 4. In the instant embodiment, five such accommodation sections 21 are provided, wherein two of them are arranged on the top side of the accommodation piece 2 and three are arranged on the bottom side of the accommodation piece 2, this being provided as an example, but not limited thereto.

In addition, the accommodation piece 2, which in an example is made of a plastic material, is set in or fill in the main-body hollowed section 12 formed in the wrench body 1, could help reduce the total weight of the present invention and also lowers the cost or expenditure of fabrication of the present invention, to thereby achieve an effect of being light-weighted, providing the present invention with both functions of storage or stowage and adjustability of the length force arm, and also realizing advantages of reduction of weight and saving of cost.

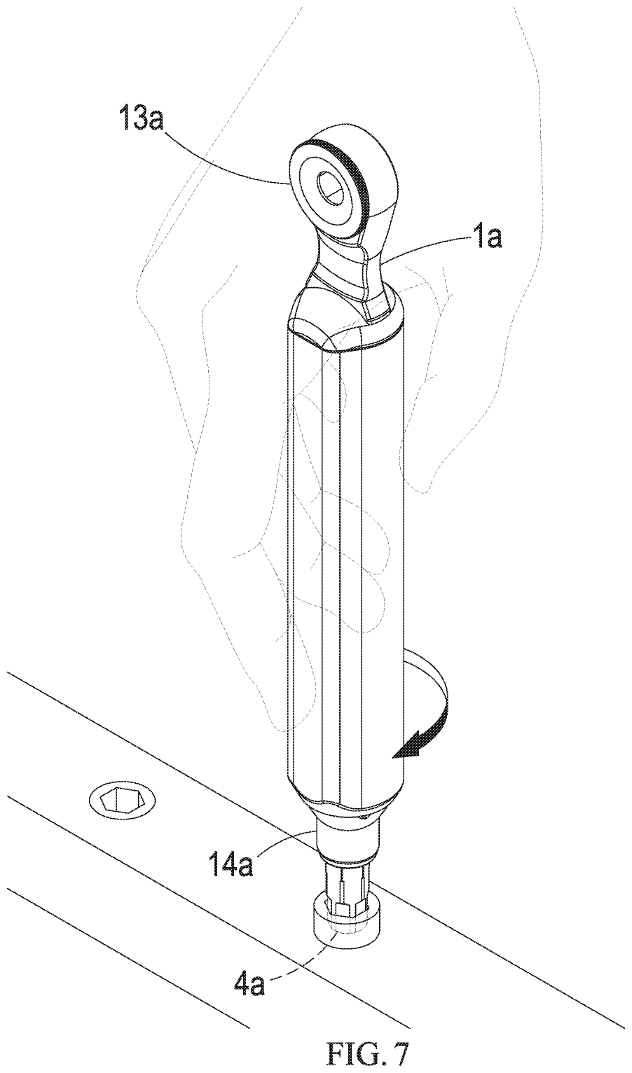

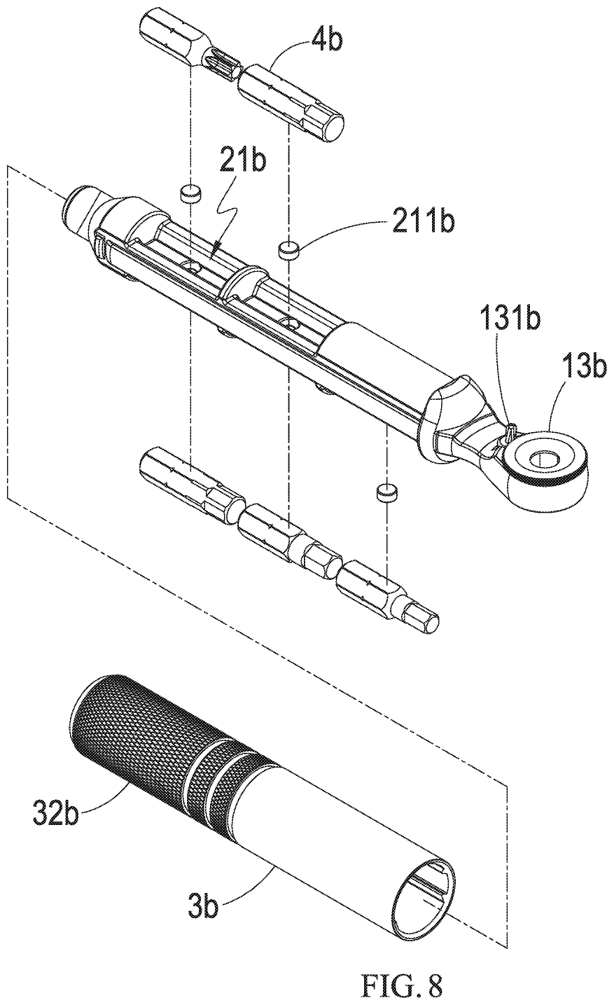

Referring to FIGS. 7 and 8, the wrench body la is provided, on one side thereof that is opposite to the ratchet assembly 13a, with a socket member 14a, and the socket member 14a. is provided with a socket magnetic-attraction section 141a. The socket magnetic-attraction section 141a is exemplified as magnet, which is provided herein as an example.

Since the tool bit 4a is generally made of a metallic material, the above-described structure of the socket magnetic-attraction section 141a would allow the user to attach or mount a tool bit 4a to the socket member 14a, and as such, in a case where there is no need to apply a force of an enlarged magnitude and there is a desire to save time, the user may use the socket member 14a to achieve a function of a screwdriver, allowing the present invention to achieve a different way of embodiment.

Referring to FIG. 8, the extension housing 3b is provided with at least an anti-slipping section 32b, and the ratchet assembly 13b is provided with a direction-changing section 131b. The accommodation section 21b comprises at least an accommodation magnetic-attraction section 211b. The anti-slipping section 32b is made in the form of a diamond check like pattern or knurling and is formed to circumferentially surround the extension housing 3b, this being provided as an example only, and may has a quantity of three. The accommodation magnetic-attraction section 211b is exemplified as a magnet and has a quantity of five and respectively set in the accommodation sections 21b.

When the user holds the extension housing 3b to carry out a tightening operation, the above-described structure of the anti-slipping section 32b provides an effect of slipping prevention and increasing a frictional force of holding and gripping to thereby assist the user to apply a force.

With the above-described structure of the direction-changing section 131b, when the user pulls the direction-changing section 131b to move to one side, an effect of engagement with the ratchet assembly 13b is induced, allowing the ratchet assembly 13b to drive the tool bit 4b for twisting in a clockwise direction; oppositely, when the user pulls the direction-changing section 131b toward an opposite side, the direction-changing section 131b similarly fulfill an effect of engagement with the ratchet, allowing the ratchet assembly 13b to drive the tool bit 4b to twist in a counterclockwise direction In this way, the ratchet assembly 13b of the present invention could do rotation or twisting in both directions, in a selective manner, in order to be used for various applications.

Further, with the structural arrangement of the accommodation magnetic-attraction section 211b in the accommodation section 21b, an effect of magnetic attraction to a tool bit 4b stowed in the accommodation section 21b could be generated to ensure stable storage of the tool bit 4b in the accommodation section 21b and also to prevent the tool bit 4b from easily falling out of the accommodation section 21b.

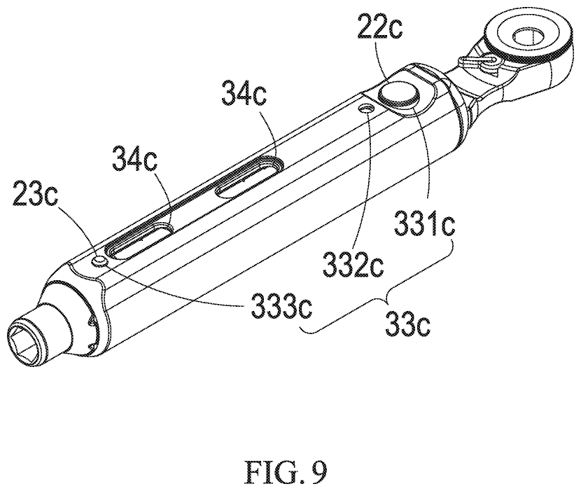

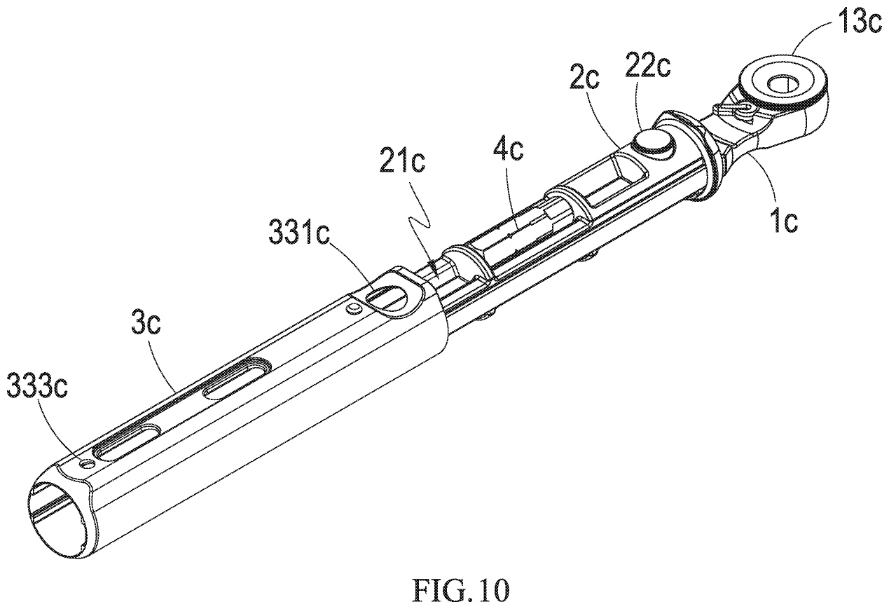

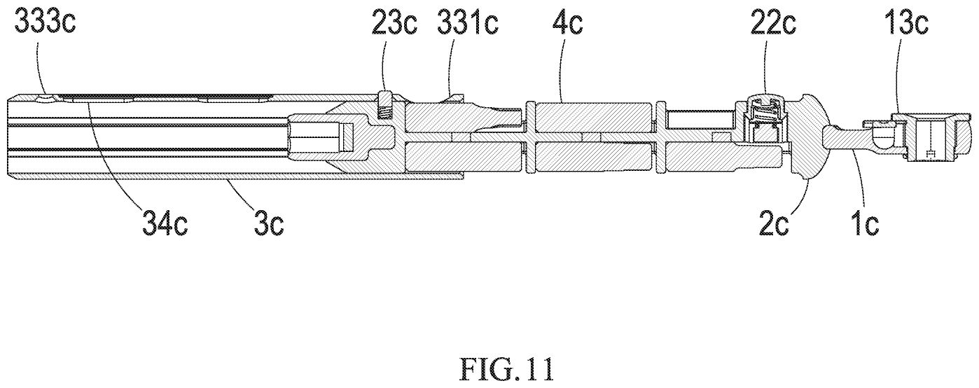

Referring to FIGS. 9-11, the extension housing 3c is provided with at least a housing retaining engagement section 33c, and in the instant embodiment, the housing retaining engagement section 33c comprises a first housing retaining engagement section 331c arranged at one side portion of the extension housing 3c, a second housing retaining engagement section 332c arranged one side of the first housing retaining engagement section 331c, and a third housing retaining engagement section 333c arranged at an opposite side portion of the extension housing 3c. The first housing retaining engagement section 331c, the second housing retaining engagement section 332c, and the third housing retaining engagement section 333c are all exemplified as circular holes. The extension housing 3c comprises at least a housing hollowed section 34c, and the housing hollowed section 34c is exemplified as having a quantity of two.

Further, the accommodation piece 2c is provided, at one side thereof that is adjacent to the ratchet assembly 13c, with a positioning retaining-engagement section 22c that corresponds to and is engageable with and thus retained to the first housing retaining engagement section 331c, and the accommodation piece 2c is provided, at one side thereof that is opposite to the ratchet assembly 13c, with an extension retaining-engagement section 23c that is selectively corresponding to and engageable with and thus retained to the second housing retaining engagement section 332c or the third housing retaining engagement section 333c. The positioning retaining-engagement section 22c and the extension retaining-engagement section 23c are both exemplified as a resilient button.

With the above-described structure, when the user attempts to have the wrench body 1c slid out of the extension housing 3c to adjust an overall length thereof in order to carry out a tightening operation, the positioning retaining-engagement section 22c and the extension retaining-engagement section 23c are first pressed down to release the retaining engagement of the positioning retaining-engagement section 22c from the first housing retaining engagement section 331c and also to release the retaining engagement of the extension retaining-engagement section 23c from the third housing retaining engagement section 333c, the wrench body 1c may then be slid to have the extension retaining-engagement section 23c moved to a position corresponding to the second housing retaining engagement section 332c, and then, by means of the resilient structure of the extension retaining-engagement section 23c, the extension retaining-engagement section 23c may elastically pop up through the second housing retaining engagement section 332c to thereby engage with and be thus retained in the second housing retaining engagement section 332c to set the wrench body 1c and the extension housing 3c in such an extended condition and prevent, during a process of tightening, the wrench body 1c or the extension housing 3c from slipping or sliding.

After the tightening operation, the user, with an attempt have the wrench body 1c slid back into the extension housing 3c, presses down the extension retaining-engagement section 23c to release the retaining engagement of the extension retaining-engagement section 23c from the second housing retaining engagement section 332c, and then slides the extension housing 3c to have the positioning retaining-engagement section 22c and the extension retaining-engagement section 23c moved, through sliding, to locations respectively corresponding to the first housing retaining engagement section 331c and the third housing retaining engagement section 333c, and the positioning retaining-engagement section 22c and the extension retaining-engagement section 23c, by means of the resilient structures thereof, respectively and elastically pop up through the first housing retaining engagement section 331c and the third housing retaining engagement section 333c and are retained in the first housing retaining engagement section 331c and the third housing retaining engagement section 333c, setting the wrench body 1c and the extension housing 3c in the shortened condition and preventing, when not in use, the wrench body 1c from detaching from the extension housing 3c.

Further, the above-described structure of the housing hollowed section 34c allows the user to realize whether the accommodation section 21c includes a tool bit 4c positioned therein without first sliding the wrench body 1c out of the extension housing 3c, and the housing hollowed section 34c has a range or size that is smaller than a size of the tool bit 4c in order to prevent the tool bit 4c from falling out by way of the housing hollowed section 34c.

1. A structure of a ratchet wrench, generally comprising:
a wrench body, the wrench body being formed thereon with a plurality of sliding sections;
a main-body hollowed section, the main-body hollowed section being formed in the wrench body, the sliding sections being arranged at two opposite sides of the main-body hollowed section;
a ratchet assembly, being arranged at one side of the wrench body;
an accommodation piece, the accommodation piece being arranged on the wrench body at a location corresponding to the main-body hollowed section;
at least an accommodation section, the accommodation section being formed in the accommodation piece; and
an extension housing, the extension housing comprising a plurality of sliding channel sections respectively corresponding to and connectable with the sliding sections to enable sliding of the wrench body in an interior of the extension housing.

2. The structure of the ratchet wrench according to claim 1, wherein the wrench body is provided, at one side thereof that is opposite to the ratchet assembly, with a socket member.

3. The structure of the ratchet wrench according to claim 1, wherein the socket member is provided with a socket magnetic-attraction section.

4. The structure of the ratchet wrench according to claim 1, wherein the ratchet assembly is provided with a direction-changing section

5. The structure of the ratchet wrench according to claim 1, wherein the extension housing is formed with at least a housing hollowed section.

6. The structure of the ratchet wrench according to claim 1, wherein the extension housing is provided with at least an anti-slipping section.

7. The structure of the ratchet wrench according to claim 1, wherein the accommodation section is provided with at least an accommodation magnetic-attraction section.

8. The structure of the ratchet wrench according to claim 1, wherein the extension housing is provided with at least a housing retaining engagement section, and the accommodation piece is provided, at one side portion thereof that is adjacent to the ratchet assembly, with a positioning retaining-engagement section corresponding to and engageable with the housing retaining engagement section.

9. The structure of the ratchet wrench according to claim 8, wherein the accommodation piece is provided, at one side portion thereof that is opposite to the ratchet assembly, with an extension retaining-engagement section corresponding to and engageable with the housing retaining engagement section.

10. The structure of the ratchet wrench according to claim 1, wherein the accommodation section receives and stores therein at least a tool bit.
